(19) United States
(12) Patent Application Publication
(10) Pub. No.: US 2006/0239873 A1
(43) Pub. Date: Oct. 26, 2006

(54) Double dielectric barrier discharge electrode device and system

(75) Inventors: Dror Niv, Ramat Gan (IL); Amram Fried, Moshav Mishmeret (IL)

Correspondence Address: Edward Langer;c/o Shiboleth, Yisraeli, Roberts, Zisman & Co., 60th Floor, 350 Fifth Avenue, New York, NY, 10118, US

(73) Assignee: Echnologoes Ltd.

(21) Appl. No.: 11/208,014

(22) Filed: Aug. 22, 2005

Related U.S. Application Data
(60) Provisional application No. 60/603,522, filed on Aug. 23, 2004.

(51) Int. Cl. B01J 19/08; B01J 19/12

(52) U.S. Cl. 422/186.04; 422/186.07

(57) ABSTRACT

A powder-based double dielectric barrier discharge (DDBD) electrode array for use within a gas phase corona reactor (GPCR) device to be incorporated within a system for air treatment and purification designed to be operational in the production of ozone-enriched air and the disintegration of air-borne pollutants. In DDBD based GPCR systems, the energy density at a given voltage is inversely proportional to the distance between pairs of adjacent electrodes of opposite polarity. There is a significant drop in energy density as spatial separation from a discharge point is increased, such that energy becomes significantly lower even at short distances away from a discharge point. In the multi-electrode crisscross array of the present invention, the geometrical placement of the electrodes increases the efficiency of the system via two parameters, the close proximity of oppositely charged electrodes and the multiplicity of electrodes configuration, that is, crisscross arrays of electrodes.

### CROSS-REFERENCE TO RELATED APPLICATION

The present application claims priority of provisional patent application Ser. No. 60/603,522 filed Aug. 23, 2004, the contents of which are hereby incorporated by reference.

### FIELD OF THE INVENTION

The present invention relates to a plasma, double dielectric barrier discharge (DDBD) electrode gas phase corona reactor (GPCR) device and system, and more particularly, to a powder-based DDBD electrode GPCR device comprising a non-thermal-equilibrium plasma reactor usable in an ozone-generating and airborne pollutants treatment system.

### BACKGROUND OF THE INVENTION

The use of plasma and its application for treatment of air and for production of ozone has been widely known for the past couple of decades. The performance of the plasma-based reactor depends on the type of electrical discharge. In reactor cores the electrical discharges are generally termed micro-discharges, but the two terms are used interchangeably hereinafter for the sake of simplicity. The discharge itself depends on the shape of electrodes, on the nature of the inter-electrode region, and on the voltage and current waveforms used for producing the plasma.

An electrical micro-discharge results in the flow of electrical current through a material that does not normally conduct electricity, such as air. On application of a high voltage source, the normally insulating air begins to exhibit conducting characteristics, and sparks, which are a form of electrical discharge, are emitted.

Normally, air consists of neutral molecules of nitrogen, oxygen, and other gases in which electrons are tightly bound to atomic nuclei. On application of an electric field above a threshold level, some of the electrons are separated from their host atoms, leaving them as positively charged ions. The electrons and the ions are then free to move separately under the influence of the applied electric field. Their movement constitutes an electric current. This ability to conduct electrical current is one of the more important properties of plasma.

GPCR technology enables the use of electrical discharges in order to excite electrons to very high energies, while the rest of the gas stays at ambient temperature. GPCRs of the DDBD type have historically been used to produce industrial quantities of ozone, which have been used in the air and water purification fields. This process also has wide application in the treatment of air-borne pollution.

Generally, DDBD electrodes exhibit boundary problems. The abrupt, step-like change of the electrical potential at the conductor edges of the electrodes will lead to the undesired effect of arcing and subsequently to the burn-out of the electrode set-up.

### SUMMARY OF THE INVENTION

It would be desirable to achieve an improved, effective, DDBD type GPCR device for an efficient and cost-effective air treatment process.

Accordingly, it is an object of the present invention to overcome the disadvantages of the prior art and provide a powder-based DDBD electrode array for use within a GPCR device to be incorporated within a system for air treatment and purification designed to be operational in the production of ozone-enriched air and the disintegration of air-borne pollutants.

In DDBD based GPCR systems, the energy density at a given voltage is inversely proportional to the distance between pairs of adjacent electrodes of opposite polarity. There is a significant drop in energy density as spatial separation from a discharge point is increased, such that energy becomes significantly lower even at short distances away from a discharge point. In the multi-electrode crisscross array of the present invention, the geometrical placement of the electrodes increases the efficiency of the system via two parameters, the close proximity of oppositely charged electrodes and the multiplicity of electrodes configuration, that is, crisscross arrays of electrodes.

Therefore, in accordance with a preferred embodiment of the present invention, there is provided a silver graphite powder-based DDBD electrode GPCR device comprising:
a hollow tube, having a seal at one end comprising a bulk of dielectric material;
a powder filler material for filling the hollow tube; and
a metallic wire being embedded in the powder material at the other end of the hollow tube, surrounded by a seal of bulk of dielectric material through which the metallic wire extends outwardly so as to be connectable to an electrically matched power supply for generating electrical micro-discharges, with the wiring and connections insulated by a mold of dielectric material that engulfs them.

There is further provided a DDBD GPCR air treatment system for the production of ozone-enriched air and the disintegration of air-borne pollutants, the air treatment system comprising:
a DDBD reactor core for subjecting air to non-thermal plasma, wherein the reactor core comprises at least two electrodes configured in an array of opposite polarity, wherein each of the electrodes comprises
   a hollow tube, having a seal at one end thereof comprising a bulk of dielectric material;
   a powder filler material for filling the hollow tube; and
   a metallic wire being embedded in the powder filler material at the other end of the; hollow tube, surrounded by a seal of bulk of dielectric material through which the metallic wire extends outwardly so as to be connectable to an electrically matching power supply for generating electrical micro-discharges, with the wiring and connections insulated by a mold of dielectric material that engulfs them.
at least one blower for drawing air into and through the air treatment system; and
at least one air filter for filtering particulate matter.

The device of the present invention has many technology advantages, among them:
Enhancement of electrical impedance matching between power-supply and electrodes array.
Elimination of edge breakdown and arcing.
Effective electrical-matching between electrode array and power supply.
Enhancement of the mechanical durability of the electrode array.
Maximal uniformity in spatial distribution of micro-discharges between and along electrodes.
Reduction of heat generation (low energy loss).
High energy density.
High ozone generation efficiency.
Operating temperature nearly ambient temperature and under high humidity.
High chemical resistance (against acids).
High reliability: long term under continuous operation.
Easy maintenance and relatively low cost.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings (not to scale), in which like numerals designate corresponding sections or elements throughout, and in which:

FIG. 1 is longitudinal, cross-section view of a powder-filled hollow tube, comprising a double dielectric barrier discharge electrode, sealed with bulk glass material at one end, and a dielectric filler at the other end, constructed in accordance with the principles of the present invention in a preferred embodiment thereof;

FIG. 2a is a general, cross-section view of alternating rows of a plurality of oppositely charged electrodes of FIG. 1 arranged in a supporting structure, constructed in accordance with a preferred embodiment of the present invention and electrically coupled to a matching power supply unit; and

FIG. 2b is a lateral cross-section view (A-A) of the general view shown in FIG. 2a.

### DETAILED DESCRIPTION OF THE PREFERRED EMBODIMENTS

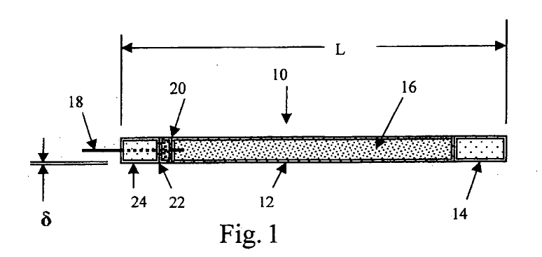

FIG. 1 is longitudinal cross-section view of a powder-filled hollow tube, comprising a dielectric-barrier electrode, sealed with bulk glass material at one end and a dielectric filler at the other end, and constructed in accordance with the principles of the present invention in a preferred embodiment thereof.

Dielectric-barrier electrode 10, comprises a hollow glass tube 12 of length L and wall thickness δ which is sealed at a first end by a bulk-glass 14 in a preferred embodiment of the invention, of length between 15δ and 20δ (depending on the applied high-voltage) and filled with a compressed powder filler material 16. Although other suitable electrode fillers may be used, as is known to those skilled in the art, in the embodiment shown, filler material 16 is silver-graphite.

In this embodiment of the invention, the hollow glass tube 12 is then plugged inside (from its second end side) with a cork 22 made of any highly electrical insulating and flexible material, such as Teflon or Polyurethane. In the preferred embodiment of the invention illustrated here, cork 22 is made of poured flexible Polyurethane.

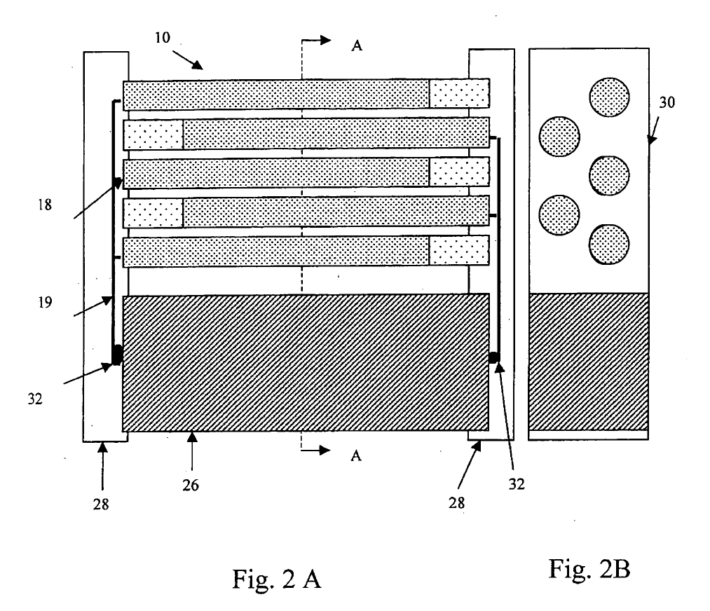

A metallic wire 18 is inserted through cork 22, slightly penetrating the surface 20 formed by the silver-graphite powder filler material 16 while slightly extending outwardly from the second end of hollow glass tube 12 to provide for a connection to a lead wire (see 19 in FIG. 2a) connecting electrode 10 to an electric power source (see 26 in FIGS. 2a/b). The second end of hollow glass tube 12 is then completely sealed with highly electrical insulating and hard material 24, which is applied to surround and seal metal wire 18 into position at the second end of glass tube 12. In a preferred embodiment of the invention, this material is made of poured hard Polyurethane, which is poured directly from the liquid phase until it hardens.

FIG. 2a is a general, cross-section view of a DDBD reactor core constructed in accordance with a preferred embodiment of the present invention and coupled to a matching power-supply unit. Electrodes 10 and power supply unit 26 are mounted and fixedly held in parallel to each other between two supporting bars 28a and 28b made of poured hard Polyurethane, which is poured directly from the liquid phase.

The resulting structure comprises a DDBD reactor core constructed in accordance with a preferred embodiment of the invention. The supporting bars 28a and 28b may be made of any other highly electrical insulating material, but in the preferred embodiment shown in FIG. 2A and FIG. 2B, the supporting bars 28a/b are made of Polyurethane. The two supporting bars 28a/b may be made in any appropriate shape to accommodate and support the electrodes 10, but in a preferred embodiment of the invention, are formed as rectangular blocks.

The electrodes 10 are mounted in an alternating array forming a group of at least two adjacent and oppositely charged electrodes comprising DDBD reactor core 30, as illustrated by way of example in FIG. 2B. In actual practice, any number electrodes 10 can be internally mounted in a fixed array to form DDBD reactor core 30, the number depending on the scale of operation required for efficient and effective air treatment and on the power supply unit. For larger-scale applications, multiple sets of modular units comprising electrodes and matching power supply units may be used to configure singlets, doublets, triplets, and higher combinations of reactor core arrays.

Each of the metallic wires 18 that protrudes from electrodes 10 extend into the supporting bars 28a/b and are internally interconnected by conducting wires 19, made of copper wire, to join like electrically charged terminals to a cable 32 comprising a high voltage lead, shown connected to high voltage power supply unit 26.

In a final step of manufacture, in accordance with the principles of the present invention, both supporting bars 28a/b are made from the same poured hard Polyurethane material used to seal the second end of the electrodes.

The gap distance between adjacent and oppositely poled electrodes is set in accordance with the respective application. For ozone generation, the gap distance is set between 1 mm and 3 mm. On the other hand, for gas (or air purification) treatment, the gap is set between 1 mm and 6 mm.

Having described the present invention with regard to certain specific embodiments thereof, it is to be understood that the description is not meant as a limitation, since further modifications may now suggest themselves to those skilled in the art, and it is intended to cover such modifications as fall within the scope of the described invention.

We claim:

1. A powder-based DDBD electrode GPCR device comprising:
a hollow tube, having a seal at one end comprising a bulk of dielectric material;
a powder filler material for filling said hollow tube; and
a metallic wire being embedded in said powder material at the other end of said hollow tube, being surrounded by a seal of a bulk of dielectric material through which said metallic wire extends outwardly so as to be connectable to an electrically matching power supply for generating electrical micro-discharges, with the wiring and connections insulated by a mold of dielectric material that engulfs them.

2. The powder-based DDBD electrode GPCR device of claim 1 wherein said powder filler material is silver graphite.

3. A DDBD GPCR air treatment system for the production of ozone-enriched air and the disintegration of air-borne pollutants, said air treatment system comprising:
a DDBD reactor core for subjecting air to non-thermal plasma, wherein said reactor core comprises at least two electrodes configured in an array of opposite polarity, wherein each of said electrodes comprises
a hollow tube, having a seal at one end thereof comprising a bulk of dielectric material;
a powder filler material for filling said hollow tube; and
a metallic wire being embedded in said powder filler material at the other end of said hollow tube, being surrounded by a seal of a bulk of dielectric material through which said metallic wire extends outwardly so as to be connectable to an electrically matching power supply for generating electrical micro-discharges, with the wiring and connections insulated by a mold of dielectric material that engulfs them;
at least one blower for drawing air into and through said air treatment system; and
at least one air filter for filtering particulate matter.

4. The DDBD GPCR air treatment system of claim 3 wherein said powder filler material is silver graphite.
